(19) United States
(12) Patent Application Publication
(10) Pub. No.: US 2023/0131347 A1
(43) Pub. Date: Apr. 27, 2023

(54) MANAGING THERMAL THROTTLING IN A MEMORY SUB-SYSTEM

(71) Applicant: Micron Technology, Inc., Boise, ID (US)

(72) Inventors: Huapeng G. Guan, Redwood City, CA (US); Horia C. Simionescu, Foster City, CA (US); Jiangli Zhu, San Jose, CA (US); Venkata Naga Lakshman Pasala, Milpitas, CA (US); Wei Wang, Dublin, CA (US)

(21) Appl. No.: 17/507,186

(22) Filed: Oct. 21, 2021

(51) Int. Cl. G06F 3/06

(52) U.S. Cl. CPC G06F 3/0653; G06F 3/0604; G06F 3/0679

(57) ABSTRACT

A plurality of temperature values of the memory device is received. A temperature value of the plurality of temperature values that satisfies a thermal throttling threshold of a plurality of thermal throttling thresholds is determined, wherein each thermal throttling threshold of the plurality of thermal throttling thresholds triggers a corresponding thermal throttling state of the memory device. In response to determining that the temperature value satisfies the respective thermal throttling threshold, a thermal throttling operation associated with the corresponding thermal throttling state is performed.

### TECHNICAL FIELD

Embodiments of the disclosure relate generally to memory sub-systems, and more specifically, relate to managing thermal throttling in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2 illustrates an example diagram of a set of thermal throttling states and a set of thermal throttling thresholds for a memory device, in accordance with some embodiments of the present disclosure.

FIG. 3 is a flow diagram of an example method to manage thermal throttling in a memory device, in accordance with some embodiments of the present disclosure.

FIG. 4 is a flow diagram of an example method to manage thermal throttling in a memory device, in accordance with some embodiments of the present disclosure.

FIG. 5 is a block diagram of an example computer system in which embodiments of the present disclosure may operate.

### DETAILED DESCRIPTION

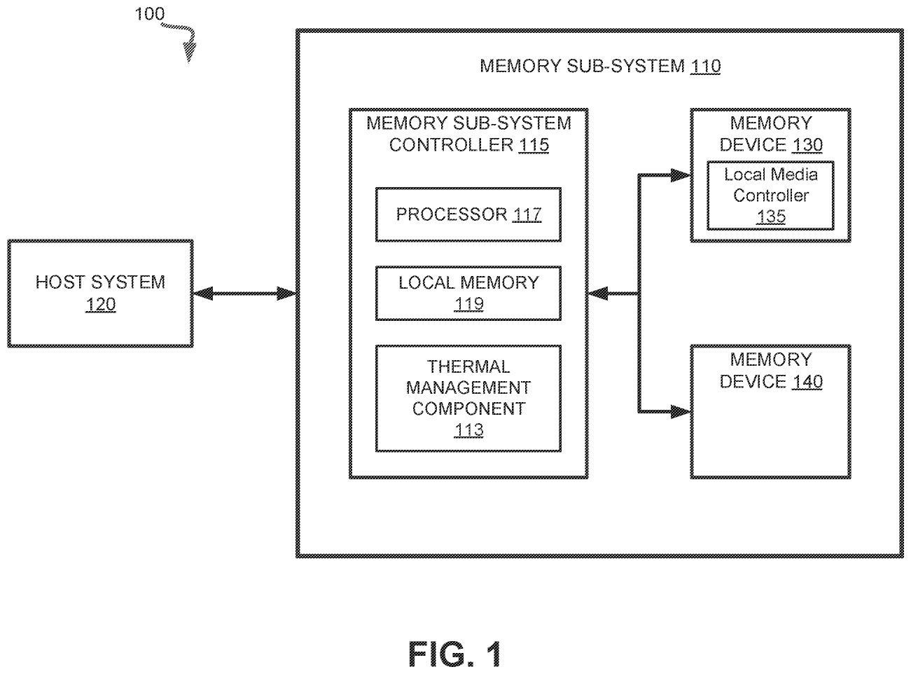

Aspects of the present disclosure are directed to managing thermal throttling in a memory sub-system. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a negative-and (NAND) memory device. Another example of non-volatile memory devices is a three-dimensional cross-point (“3D cross-point”) memory device that is a cross-point array of non-volatile memory that can perform bit storage based on a change of bulk resistance, in conjunction with a stackable cross-gridded data access array. Other examples of non-volatile memory devices are described below in conjunction with FIG. 1. A non-volatile memory device is a package of one or more dies. Each die can consist of one or more planes. For some types of non-volatile memory devices (e.g., NAND devices), each plane consists of a set of physical blocks. Each block consists of a set of pages. Each page consists of a set of memory cells (“cells”). A cell is an electronic circuit that stores information.

Thermal throttling can refer to an operation performed by a system or device to cool down the system or device in an effort to prevent thermal stress from degrading the system or device. Thermal throttling can involve limiting the number of memory access operations performed on a memory device. During operation, a system or device can generate significant amounts of thermal energy. If the thermal energy is not appropriately dissipated, the system or device can overheat and experience permanent damage. In typical memory sub-systems, a system or device has a predefined stable temperature. A desirable temperature for a system or device can be dictated by a customer. A system or device can operate while implementing thermal throttling operations but typically experiences a measurable and expected reduction in performance.

Thermal shutdown can refer to an operation performed by a system or device to prevent the system or device from exceeding a certain critical temperature that can permanently damage the system or device. Thermal shutdown can involve significantly reducing the number of memory access operations performed on a memory device. The critical temperature for a system or device is determined by the ability of various circuits to operate at this temperature without significantly degrading the performance or sustaining permanent damage. Upon reaching the critical temperature, a system or device can implement a thermal shutdown operation. The expected performance reduction of a system or device implementing a thermal shutdown operation is typically appreciably greater than the expected performance reduction of a system or device implementing a thermal throttling operation. For example, a memory sub-system that performs a thermal throttling operation can reduce the number of parallel/concurrent input and output (I/O) operations (e.g., read operations and write operations) performed. A memory sub-system that performs a thermal shutdown operation can prohibit all or normal I/O operations until the temperature of the system is reduced to an appropriate level.

Some memory sub-systems can perform thermal throttling operations using various techniques. In some implementations, a discrete temperature sensor (e.g., thermistor) is built into the memory sub-system to measure the temperature of the memory sub-system. When the measured temperature at the discrete temperature sensor reaches a particular temperature, the memory sub-system can perform a thermal throttling operation. However, a single sensor may not always accurately measure the temperature variations across the memory sub-system, which can lead to inadequate thermal protection for the memory sub-system.

In another approach, a memory sub-system estimates the thermal effect of read and write operations performed on a block of a memory device. The number of read and write operations performed on a memory device is correlated to the temperature of the memory device since read and write operations create a heating effect on the memory device. Some memory sub-systems thus use the number of active read and write operations as a proxy indicator of the temperature of the memory device. For example, some conventional memory sub-systems count the number of concurrent read and write operations being performed on a block of a memory device. If the number of concurrent memory access operations approaches a certain threshold (e.g., a number of concurrent read/write operations that corresponds to a threshold temperature of the memory device), the memory sub-system can perform a thermal throttling operation. For example, the memory sub-system can limit the maximum number of concurrent read/write operations being performed. Typically, the maximum number of concurrent read/write operations is limited by a certain number irrespective of the temperature of the memory device. With this approach, the memory sub-system will typically perform thermal throttle operations when the temperature of the memory device is within a 10 degrees range from the threshold temperature.

Aspects of the present disclosure address the above and other deficiencies by providing a memory sub-system that performs gradual thermal throttling operations based on monitoring temperatures. In certain embodiments, a memory sub-system controller can measure a set of temperature values at various components of the memory sub-system. For example, the memory sub-system controller can determine a composite temperature including a die temperature and ASIC temperature measured at a memory device of the memory sub-system. The memory sub-system controller can determine that one of the temperature values of the set of temperature values satisfies a respective thermal throttling threshold of a set of thermal throttling thresholds. For example, the memory sub-system controller can compare a temperature value (e.g., the current temperature at a block of the memory device) to the respective thermal throttling threshold and determine whether the temperature value is greater than the respective thermal throttling threshold. Each thermal throttling threshold of the set of thermal throttling thresholds can trigger a corresponding thermal throttling state of the memory device. In response to determining that the temperature value satisfies the respective thermal throttling threshold, the memory sub-system controller can perform a respective thermal throttling operation of a set of thermal throttling operations. There can be four thermal throttling states. In certain embodiments, performing a respective thermal throttling operation can include identifying a number of concurrent memory access operations being performed at a block of the memory device. The memory sub-system controller can reduce the number of concurrent memory access operations by a predefined number (e.g., 50%). In certain embodiments, performing a respective thermal throttling operation can include identifying the number of concurrent memory access operations being performed at a block of the memory device. The memory sub-system controller can increase the number of concurrent memory access operations by a predefined number (e.g., 2). In certain embodiments, performing a respective thermal throttling operation can include identifying the number of concurrent memory access operations being performed at a block of the memory device. The memory sub-system controller can set the number of concurrent memory access operations equal to a predefined minimum value (e.g., 1). In certain embodiments, performing a respective thermal throttling operation can include identifying the number of concurrent memory access operations being performed at a block of the memory device. The memory sub-system controller can set the number of concurrent memory access operations equal to a predefined maximum value (e.g., 10).

Advantages of the present disclosure include, but are not limited to improving the I/O performance of the memory sub-system by more effectively controlling thermal throttling operations for various temperatures of the memory device. By having multiple thermal throttling thresholds and performing multiple thermal throttling operations within a narrow throttling temperature range (e.g., 65 degrees to 70 degrees Celsius), the memory sub-system can more accurately achieve a stable temperature and I/O performance.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a negative-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks. Some types of memory, such as 3D cross-point, can group pages across dice and channels to form management units (MUs).

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical MU address, physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 includes a thermal management component 113 that can be used to manage thermal throttling for a memory device (e.g., the memory device 130). In some embodiments, the memory sub-system controller 115 includes at least a portion of the thermal management component 113. In some embodiments, the thermal management component 113 is part of the host system 110, an application, or an operating system. In other embodiments, local media controller 135 includes at least a portion of the thermal management component 113 and is configured to perform the functionality described herein.

The thermal management component 113 can measure a set of temperature values at various components of the memory sub-system. For example, the thermal management component 113 can determine a composite temperature including a die temperature and ASIC temperature measured at a memory device of the memory sub-system. The thermal management component 113 can determine that one of the temperature values of the set of temperature values satisfies a respective thermal throttling threshold of a set of thermal throttling thresholds. In some embodiments, each thermal throttling threshold can be determined from memory media thermal property and ASIC/PCB board characterization. The thermal management component 113 can compare the temperature value to the respective thermal throttling threshold and determine whether the temperature value is greater than the respective thermal throttling threshold. Each thermal throttling threshold of the set of thermal throttling thresholds can trigger a corresponding thermal throttling state of the memory device. In response to determining that the temperature value satisfies the respective thermal throttling threshold, the thermal management component 113 can perform a respective thermal throttling operation of a set of thermal throttling operations. Further details with regards to the operations of the thermal management component 113 are described below.

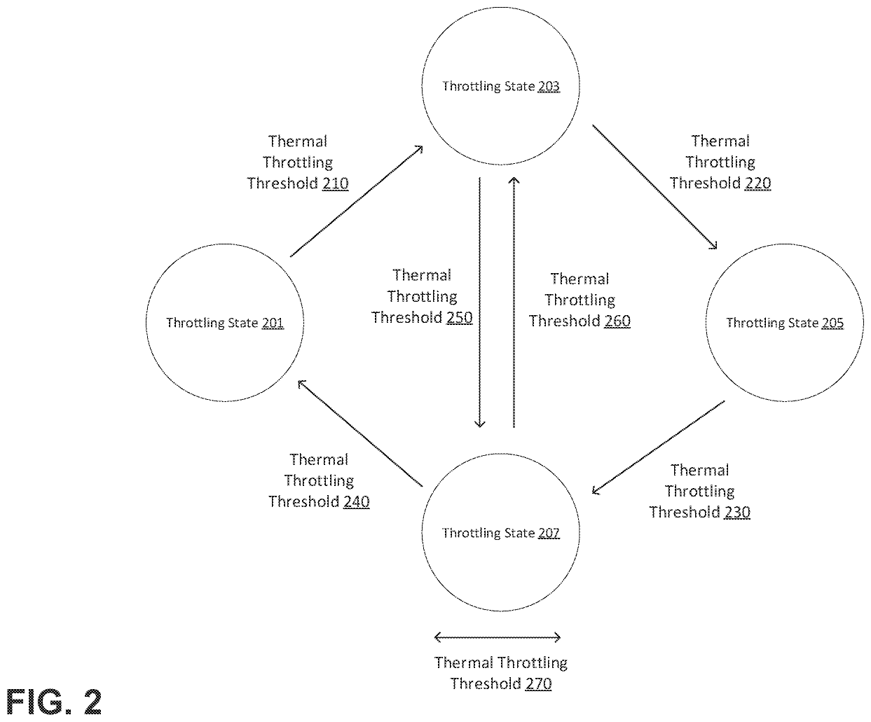

FIG. 2 illustrates an example state machine which can be implemented by the memory sub-system controller, in accordance with some embodiments of the present disclosure. At any given time, the memory device can be in a certain thermal throttling state determined by the memory device temperature. Accordingly, a thermal management component (e.g., the thermal management component 113 of FIG. 1) can perform one or more thermal throttling operations associated with the current thermal throttling state. For example, as illustrated in FIG. 2, the memory device can include a throttling state 201, throttling state 203, throttling state 205, and throttling state 207. In some embodiments, throttling state 201 is the “Disabled State,” in which no thermal throttling operations need to be performed. In some embodiments, throttling state 203 is the “Alarm State,” in which a rapid thermal throttling operation can be performed, e.g., by reducing the number of concurrent memory access operations being performed at the memory device. In some embodiments, throttling state 205 can be the “Max State,” in which the maximum thermal throttling operation can be performed, e.g., by drastically reducing the number of concurrent memory access operations being performed at the memory device. In some embodiments, throttling state 207 is the “Stable State,” in which a gradual thermal throttling operation can be performed, e.g., by slightly reducing the number of concurrent memory access operations being performed at the memory device.

State transitions can be defined by the set of thermal throttling threshold, such that each thermal throttling state can be triggered by a corresponding thermal throttling threshold, e.g., thermal throttling threshold 210, thermal throttling threshold 220, thermal throttling threshold 230, thermal throttling threshold 240, thermal throttling threshold 250, thermal throttling threshold 260, and thermal throttling threshold 270. Each thermal throttling threshold can be defined by a corresponding temperature value. As described in more details herein below, a thermal management component (e.g., the thermal management component 113 of FIG. 1) can determine a set of composite temperature values of the memory device measured at different H/W areas of the memory device at consecutive measurement times, including the temperature of the memory device die, ASIC temperature, and/or PCBA temperature. The thermal management component can determine whether the temperature of the memory device satisfies a thermal throttling threshold. In response to determining that the one or more temperature values satisfies the thermal throttling threshold, the thermal management component can transition into the state triggered by the thermal throttling threshold and perform one or more thermal throttling operations associated with the thermal throttling state triggered by the thermal throttling threshold.

In one embodiment, the thermal management component can determine that the one or more temperature values satisfies the thermal throttling threshold 210. Satisfying the thermal throttling threshold 210 can include determining that a current temperature (Tₙ) of the memory device is greater than a threshold temperature (T₁) associated with the memory device. The threshold temperature T₁ can be a temperature equal to or greater than a critical temperature associated with a failure of the memory device (e.g., an overheating condition of the memory device). Determining that the thermal throttling threshold 210 is satisfied can trigger transitioning from the throttling state 201 to the throttling state 203. In response to determining that the thermal throttling threshold 210 is satisfied, the thermal management component can perform the set of thermal throttling operations associated with the transition from the throttling state 201 to the throttling state 203. In one embodiment, performing the set of thermal throttling operations can include performing a reduction operation on the number of concurrent memory access operations. The reduction operation can include reducing the number of concurrent memory access operations by 50%.

In one embodiment, the thermal management component can determine that the one or more temperature values satisfies the thermal throttling threshold 220. Satisfying the thermal throttling threshold 220 can include determining that the current temperature Tₙ of the memory device is greater than the threshold temperature T₂ associated with the memory device. The threshold temperature T₂ can be a temperature equal to or greater than the critical temperature associated with a failure of the memory device (e.g., an overheating condition of the memory device). The threshold temperature T₂ can be greater than the threshold temperature T₁. Determining that the thermal throttling threshold 220 is satisfied can trigger transitioning from any of the throttling states to the throttling state 205. In some embodiments, determining that the thermal throttling threshold 220 is satisfied can trigger transitioning from the throttling state 203 to the throttling state 205. In response to determining that the thermal throttling threshold 220 is satisfied, the thermal management component can perform the set of thermal throttling operations associated with the transitioning to the throttling state 205. In one embodiment, performing the set of thermal throttling operations can include setting the number of concurrent memory access operations to the minimum number of concurrent memory access operations (e.g., 1 memory access operation).

In one embodiment, the thermal management component can determine that the one or more temperature values satisfies the thermal throttling threshold 250. Satisfying the thermal throttling threshold 250 can include determining that the current temperature Tₙ is less than the previous temperature Tₙ₋₁ and that the previous temperature Tₙ₋₁ is less than or equal to a second previous temperature Tₙ₋₂. Determining that the current temperature Tₙ is less than the previous temperature Tₙ₋₁ and that the previous temperature Tₙ₋₁ is less than or equal to the second previous temperature Tₙ₋₂ can trigger transitioning from the throttling state 203 to the throttling state 207. In response, the thermal management component can perform the set of thermal throttling operations associated with the transition from the throttling state 203 to the throttling state 207. In one embodiment, performing the set of thermal throttling operations can include increasing the number of concurrent memory access operations by a predefined number. The predefined number can be determined based on thermal throttling algorithm modeling and/or through memory device behavior characterization with the thermal throttling algorithm. The thermal management component can determine that the number of concurrent memory access operations is less than or equal to a maximum number of concurrent memory access operations. In response to determining that the number of concurrent memory access operations is not less than or equal to the maximum number of concurrent memory access operations, the thermal management component can set the number of concurrent memory access operations equal to the maximum number of concurrent memory access operations.

In one embodiment, the thermal management component can determine that the one or more temperature values satisfies the thermal throttling threshold 230. Satisfying the thermal throttling threshold 230 can include determining that the current temperature Tₙ is less than the threshold temperature T₂ and that a previous temperature Tₙ₋₁ is less than the threshold temperature T₂. Determining that the thermal throttling threshold 230 is satisfied can include trigger transitioning from the throttling state 205 to the throttling state 207. In response to determining that the thermal throttling threshold 230 is satisfied, the thermal management component can perform the set of thermal throttling operations associated with the transition from the throttling state 205 to the throttling state 207. In one embodiment, performing the set of thermal throttling operations can include setting the number of concurrent memory access operations to the minimum number of concurrent memory access operations (e.g., 1 memory access operation).

In one embodiment, the thermal management component can determine that the one or more temperature values satisfies the thermal throttling threshold 270. Satisfying the thermal throttling threshold 270 can include determining that the current temperature Tₙ is less than the previous temperature Tₙ₋₁ and that the previous temperature Tₙ₋₁ is less than the second previous temperature Tₙ₋₂. Determining that the current temperature Tₙ is less than the previous temperature Tₙ₋₁ and that the previous temperature Tₙ₋₁ is less than or equal to the second previous temperature Tₙ₋₂ can cause remaining in a throttling state, e.g., remaining in the throttling state 207. In response, the thermal management component can perform a set of thermal throttling operations. In one embodiment, performing the set of thermal throttling operations can include performing an addition operation on the number of concurrent memory access operations. The addition operation can include adding a predefined value (e.g., 2) to the number of concurrent memory access operations. The predefined number can be determined based on thermal throttling algorithm modeling and/or through memory device behavior characterization with the thermal throttling algorithm. The thermal management component can determine that the number of concurrent memory access operations is less than or equal to a maximum number of concurrent memory access operations. In response to determining that the number of concurrent memory access operations is not less than or equal to the maximum number of concurrent memory access operations, the thermal management component can set the number of concurrent memory access operations equal to the maximum number of concurrent memory access operations.

In one embodiment, satisfying the thermal threshold 270 can include determining that the current temperature Tₙ is greater than the previous temperature Tₙ₋₁. Determining that the current temperature Tₙ is greater than the previous temperature Tₙ₋₁ can cause remaining in the throttling state, e.g., remaining in the throttling state 207. In response, the thermal management component can perform another set of thermal throttling operations. In one embodiment, performing the set of thermal throttling operations can include performing a reduction operation on the number of concurrent memory access operations. The reduction operation can include reducing the number of concurrent memory access operations by a predefined number. The predefined number can be determined based on thermal throttling algorithm modeling and/or through memory device behavior characterization with the thermal throttling algorithm. The thermal management component can determine that the number of concurrent memory access operations is greater than or equal to the minimum number of concurrent memory access operations. In response to determining that the number of concurrent memory access operations is less than to the minimum number of concurrent memory access operations, the thermal management component can set the number of concurrent memory access operations equal to the minimum number of concurrent memory access operations.

In one embodiment, satisfying the thermal threshold 240 can include determining that the current temperature Tₙ is less than the threshold temperature T₁ and that the previous temperature Tₙ₋₁ is less than the threshold temperature T₁. Determining that the current temperature Tₙ is less than the threshold temperature T₁ and that the previous temperature Tₙ₋₁ is less than the threshold temperature T₁ can trigger transitioning from the throttling state 207 to the throttling state 201. In response, the thermal management component can perform another set of thermal throttling operations. In one embodiment, performing the set of thermal throttling operations can include setting the number of concurrent memory access operations equal to the maximum number of memory access operations.

In one embodiment, satisfying the thermal threshold 260 can include determining that the current temperature Tₙ is greater than the previous temperature Tₙ₋₁ and that the previous temperature Tₙ₋₁ is greater than or equal to the second previous temperature Tₙ₋₂. Determining that the current temperature Tₙ is greater than the previous temperature Tₙ₋₁ and that the previous temperature Tₙ₋₁ is greater than or equal to the second previous temperature Tₙ₋₂ can trigger transitioning from the throttling state 207 to the throttling state 203. In response to determining that the thermal throttling threshold 260 is satisfied, the thermal management component can perform the set of thermal throttling operations associated with the transitioning from the throttling state 207 to the throttling state 203. In one embodiment, performing the set of thermal throttling operations can include performing a reduction operation on the number of concurrent memory access operations. The reduction operation can include reducing the number of concurrent memory access operations by 50%. The thermal management component can determine that the number of concurrent memory access operations is greater than or equal to the minimum number of concurrent memory access operations. In response to determining that the number of concurrent memory access operations is not greater than or equal to the minimum number of concurrent memory access operations, the thermal management component can set the number of concurrent memory access operations equal to the minimum number of concurrent memory access operations.

More details with regards to managing thermal throttling are explained herein below.

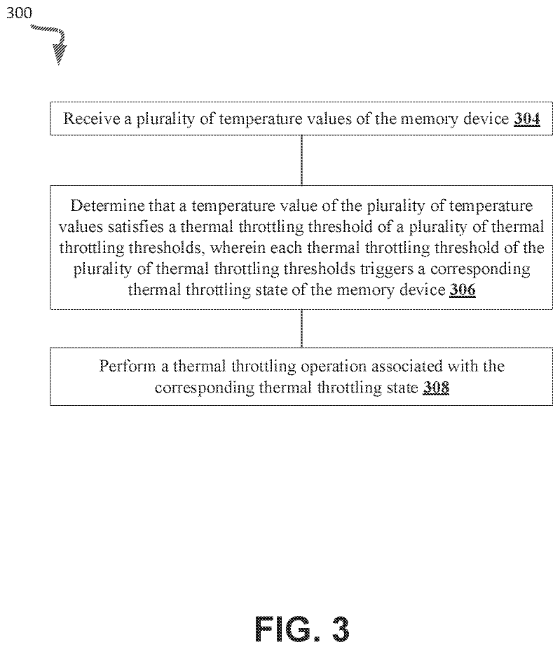

FIG. 3 is a flow diagram of an example method 300 for managing thermal throttling in a memory device, in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the thermal management component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 304, the processing logic receives a set of composite temperature values. In some embodiments, the set of composite temperatures can include one or more composite temperature values. Each composite temperature value can be indicative of a temperature at the memory device. For example, each composite temperature value can be derived from a set of temperatures measured at the memory device. Measuring the set of temperatures at the memory device can include measuring the temperature at a media die of the memory device and an ASIC temperature and a PCBA temperature. In one embodiment, the set of composite temperature values can include a current temperature Tₙ of a die of the memory device and/or the memory device, a threshold temperature T₁, threshold temperature T₂, a shutdown temperature T_{c}, and a set of previous temperatures Tₙ₋₁, Tₙ₋₂, etc. In some embodiments, the threshold temperature T₁ is a temperature less than the threshold temperature T₂. For example, the threshold temperature T₁ can be a temperature of 65 degrees Celsius, and the threshold temperature T₂ can be a temperature of 68 degrees Celsius. In some embodiments, the threshold temperatures can be provided by a user and/or customer. In some embodiments, the processing logic can measure the set of composite temperatures at the memory device using a frequency of a set of frequencies. Each frequency can indicate a period of wait time between measuring each set of temperatures. The frequency used in measuring the set of temperatures can be adjusted based on the current temperature of the die and/or the memory device. For example, if the current temperature is below 65 degrees Celsius, the frequency can be every 5 seconds. If the current temperature is between 65 degrees Celsius and 67 degrees Celsius, the frequency can be every 3 seconds. If the current temperature is greater than 67 degrees Celsius, the frequency can be every 1 second.

At operation 306, the processing logic determines that a temperature value of the set of composite temperature values satisfies a thermal throttling threshold of a set of thermal throttling thresholds. In one embodiment, the processing logic can determine that the temperature value satisfies the thermal throttling threshold by comparing the temperature value to the respective thermal throttling threshold. Each thermal throttling threshold can trigger a corresponding thermal throttling state of the memory device. In some embodiments, there can be four different thermal throttling states. For example, there can be a “Disabled State,” an “Alarm State,” a “Max State,” and a “Stable State.” Each thermal throttling state can be associated with one or more thermal throttling thresholds. Determining that the temperature value satisfies the respective thermal throttling threshold is described in detail with regard to FIG. 2. In response to determining that the temperature value satisfies the respective thermal throttling threshold, the processing logic can transition from one state to another state. The processing logic can determine whether to transition from one to another state based on the thermal throttling threshold that is satisfied. In some embodiments, in response to determining that the temperature value satisfies the respective thermal throttling threshold, the processing logic can remain in the same state. The processing logic can determine whether to remain in the same state based on the thermal throttling threshold that is satisfied. In some embodiments, the processing logic determines that the temperature value does not exceed a respective thermal shutdown threshold of a set of thermal shutdown thresholds. For example, the processing logic can determine that the current memory device die, ASIC, and/or PCBA temperatures corresponding to composite temperature Tₙ is less than the respective thermal shutdown threshold. In one embodiment, the respective thermal shutdown threshold is a die temperature of 70 degrees Celsius or greater. In one embodiment, the respective thermal shutdown threshold is an ASIC temperature of 110 degrees Celsius or greater. In one embodiment, the respective shutdown threshold is a PCBA temperature of 100 degrees Celsius or greater. In some embodiments, in response to determining that the temperature value exceeds the respective thermal shutdown threshold, the processing logic can shut down the memory device.

At operation 308, the processing logic performs a thermal throttling operation. In some embodiments, the thermal throttling operation is associated with the corresponding thermal throttling state. In some embodiments, the processing logic performs the thermal throttling operation in response to determining that the temperature value satisfies the respective thermal throttling threshold. Performing the thermal throttling operation is described in detail with regard to FIG. 2. In some embodiments, performing the thermal throttling operation can include determining a number of concurrent memory access operations being actively performed at a block of the memory device. In some embodiments, the memory access operations can be write operations being performed in response to a request from a host system. The processing logic can reduce the number of concurrent memory access operations by a predefined percentage. The predefined percentage can depend on the corresponding thermal throttling state of the memory device. For example, the processing logic can reduce the number of concurrent memory access operations by 50%. In another example, the processing logic can reduce the number of concurrent memory access operations by a predefined value, e.g., 2. The predefined value can depend on the corresponding thermal throttling state of the memory device. In response to reducing the number of concurrent memory access operations, the processing logic can determine that the number of concurrent memory access operations satisfies a minimum threshold criterion. The minimum threshold criterion can be determined by maintaining host I/O operation. In some embodiments, in response to reducing the number of concurrent memory access operations, the processing logic can determine that the number of concurrent memory access operations does not satisfy the minimum threshold criterion. In response to determining that the number of concurrent memory access operations does not satisfy the minimum threshold criterion, the processing logic can set the number of concurrent memory access operations equal to a predefined minimum value. For example, the minimum threshold criterion can be 1 memory access operation.

In some embodiments, performing the thermal throttling operation can include determining the number of concurrent memory access operations being performed at the block of the memory device. The processing logic can increase the number of concurrent memory access operations. For example, the processing logic can increase, by a predefined value (e.g., 2), the number of concurrent memory access operations. The predefined value can depend on the corresponding thermal throttling state of the memory device. In response to increasing the number of concurrent memory access operations, the processing logic can determine that the number of concurrent memory access operations satisfies a maximum threshold criterion. The maximum threshold criterion can be determined by ASIC design, which is determined to achieve the maximum I/O performance of the memory device/product specification. In some embodiments, in response to increasing the number of concurrent memory access operations, the processing logic can determine that the number of concurrent memory access operations does not satisfy the maximum threshold criterion. In response to determining that the number of concurrent memory access operations does not satisfy the maximum threshold criterion, the processing logic can set the number of concurrent memory access operations equal to a predefined maximum value. For example, the maximum threshold criterion can be 32 memory access operations.

Further details with regard to performing each thermal throttling operation are described with reference to FIG. 2 herein above.

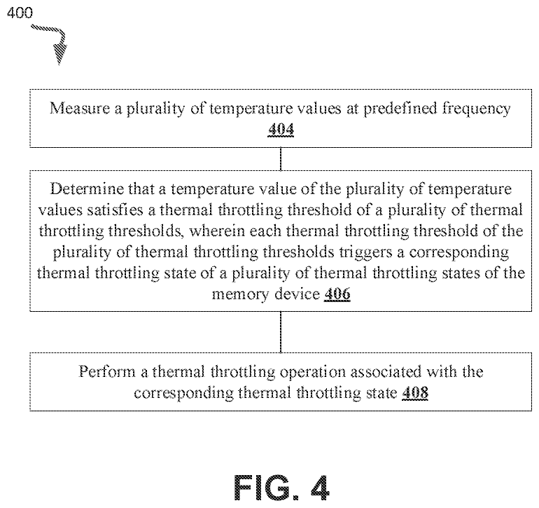

FIG. 4 is a flow diagram of an example method 400 for managing thermal throttling in a memory device, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the thermal management component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 404, the processing logic measures a set of temperatures values of the memory device at a frequency. In some embodiments, the set of temperature values can include one or more temperature values. Measuring the set of temperature values at the memory device can include measuring the temperature at a media die of the memory device and an ASIC temperature and a PCBA temperature during a period of time. In one embodiment, a set of composite temperature values can be derived from the set of temperature values measured at the memory device. The set of composite temperature values can include a composite temperature Tₙ of a die of the memory device and/or the memory device, a threshold temperature T₁, threshold temperature T₂, a shutdown temperature T_{c}, and a set of previous composite temperatures Tₙ₋₁, Tₙ₋₂, etc. In some embodiments, the threshold temperature T₁ is a temperature less than the threshold temperature T₂. For example, the threshold temperature T₁ can be a temperature of 65 degrees Celsius, and the threshold temperature T₂ can be a temperature of 68 degrees Celsius. In some embodiments, the threshold temperatures can be provided by a user and/or customer. In some embodiments, the processing logic can measure the set of temperature values at the memory device using a frequency of a set of frequencies. Each frequency can indicate a period of wait time between measuring each set of temperatures. The frequency used in measuring the set of temperature values can be adjusted based on the current temperature of the die and/or the memory device. For example, if the current temperature is below 65 degrees Celsius, the frequency can be every 5 seconds. If the current temperature is between 65 degrees Celsius and 67 degrees Celsius, the frequency can be every 3 seconds. If the current temperature is greater than 67 degrees Celsius, the frequency can be every 1 second.

At operation 406, the processing logic determines that a temperature value of the set of temperature values satisfies a thermal throttling threshold of a set of thermal throttling thresholds. In one embodiment, the processing logic can determine that the temperature value satisfies the thermal throttling threshold by comparing the temperature value to the respective thermal throttling threshold. Each thermal throttling threshold can trigger a corresponding thermal throttling state of the memory device. In some embodiments, there can be four different thermal throttling states. For example, there can be a “Disabled State,” an “Alarm State,” a “Max State,” and a “Stable State.” Each thermal throttling state can be associated with one or more thermal throttling thresholds. Determining that the temperature value satisfies the respective thermal throttling threshold is described in detail with regard to FIG. 2. In response to determining that the temperature value satisfies the respective thermal throttling threshold, the processing logic can transition from one state to another state. The processing logic can determine whether to transition from one to another state based on the thermal throttling threshold that is satisfied. In some embodiments, in response to determining that the temperature value satisfies the respective thermal throttling threshold, the processing logic can remain in the same state. The processing logic can determine whether to remain in the same state based on the thermal throttling threshold that is satisfied. In some embodiments, the processing logic determines that the temperature value does not exceed a respective thermal shutdown threshold of a set of thermal shutdown thresholds. For example, the processing logic can determine that the current temperature Tₙ is less than the respective thermal shutdown threshold. In one embodiment, the respective thermal shutdown threshold is a die temperature of 70 degrees Celsius or greater. In one embodiment, the respective thermal shutdown threshold is an ASIC temperature of 110 degrees Celsius or greater. In one embodiment, the respective shutdown threshold is a PCBA temperature of 100 degrees Celsius or greater. In some embodiments, in response to determining that the temperature value exceeds the respective thermal shutdown threshold, the processing logic can shut down the memory device.

At operation 408, the processing logic performs a thermal throttling operation. In some embodiments, the thermal throttling operation is associated with the corresponding thermal throttling state. In some embodiments, the processing logic performs the thermal throttling operation in response to determining that the temperature value satisfies the respective thermal throttling threshold. Performing the thermal throttling operation is described in detail with regard to FIG. 2. In some embodiments, performing the thermal throttling operation can include determining a number of concurrent memory access operations being actively performed at a block of the memory device. In some embodiments, the memory access operations can be write operations being performed in response to a request from a host system. The processing logic can reduce the number of concurrent memory access operations by a predefined percentage. For example, the processing logic can reduce the number of concurrent memory access operations by 50%. The predefined percentage can depend on the corresponding thermal throttling state of the memory device. In another example, the processing logic can reduce the number of concurrent memory access operations by a predefined value, e.g., 2. The predefined value can depend on the corresponding thermal throttling state of the memory device. In response to reducing the number of concurrent memory access operations, the processing logic can determine that the number of concurrent memory access operations satisfies a minimum threshold criterion. The minimum threshold criterion can be determined based on offline device testing. In some embodiments, in response to reducing the number of concurrent memory access operations, the processing logic can determine that the number of concurrent memory access operations does not satisfy the minimum threshold criterion. In response to determining that the number of concurrent memory access operations does not satisfy the minimum threshold criterion, the processing logic can set the number of concurrent memory access operations equal to a predefined minimum value. For example, the minimum threshold criterion can be 1 memory access operation.

In some embodiments, performing the thermal throttling operation can include determining the number of concurrent memory access operations being performed at the block of the memory device. The processing logic can increase the number of concurrent memory access operations. For example, the processing logic can add a predefined value (e.g., 2) to the number of concurrent memory access operations. The predefined value can depend on the corresponding thermal throttling state of the memory device. In response to increasing the number of concurrent memory access operations, the processing logic can determine that the number of concurrent memory access operations satisfies a maximum threshold criterion. The maximum threshold criterion can be determined based on offline device testing. In some embodiments, in response to increasing the number of concurrent memory access operations, the processing logic can determine that the number of concurrent memory access operations does not satisfy the maximum threshold criterion. In response to determining that the number of concurrent memory access operations does not satisfy the maximum threshold criterion, the processing logic can set the number of concurrent memory access operations equal to a predefined maximum value. For example, the maximum threshold criterion can be 32 memory access operations.

Further details with regard to performing each thermal throttling operation are described with reference to FIG. 2 herein above.

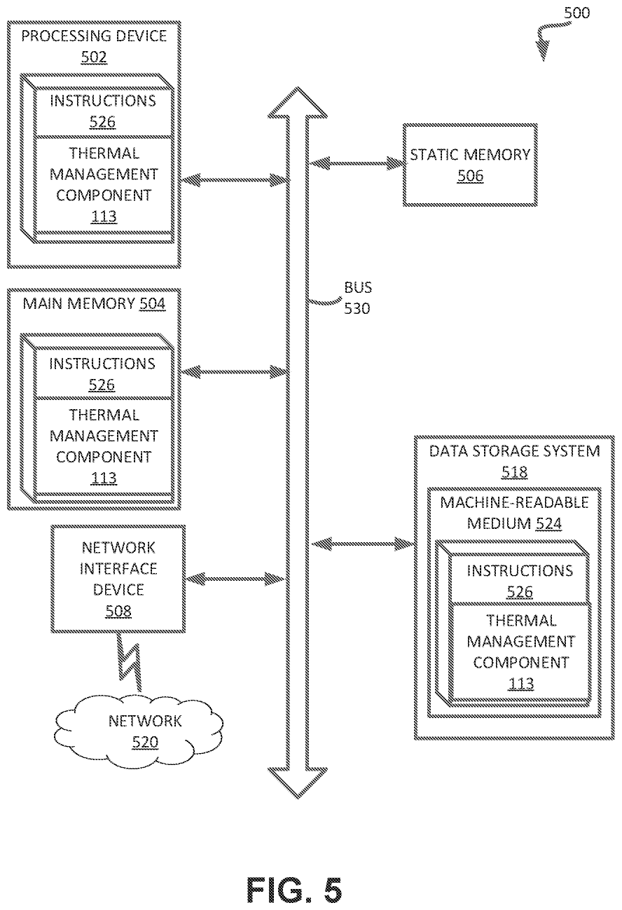

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the write disturb management component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or RDRAM, etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to a thermal management component (e.g., the thermal management component 113 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device; and
a processing device, operatively coupled with the memory device, to perform operations comprising:
receiving a plurality of temperature values of the memory device;
determining that a temperature value of the plurality of temperature values satisfies a thermal throttling threshold of a plurality of thermal throttling thresholds, wherein each thermal throttling threshold of the plurality of thermal throttling thresholds triggers a corresponding thermal throttling state of the memory device; and
responsive to determining that the temperature value satisfies the respective thermal throttling threshold, performing a thermal throttling operation associated with the corresponding thermal throttling state.

2. The system of claim 1, further comprising four thermal throttling states.

3. The system of claim 2, further comprising:
measuring the plurality of temperature values at a respective frequency, wherein the respective frequency indicates a period of time between measuring the plurality of temperature values, and wherein the respective frequency is adjustable based at least on the current temperature of the memory device.

4. The system of claim 1, wherein performing the thermal throttling operation comprises:
identifying a number of concurrent memory access operations being performed at a block of the memory device; and
reducing, by a respective predefined number, the number of concurrent memory access operations, wherein the respective predefined number is based on the corresponding thermal throttling state.

5. The system of claim 4, further comprising:
responsive to determining that the number of concurrent memory access operations does not satisfy a minimum threshold criterion, setting the number of concurrent memory access operations equal to a predefined minimum value.

6. The system of claim 1, wherein performing the thermal throttling operation comprises:
identifying a number of concurrent memory access operations being performed at a block of the memory device; and
increasing, by a predefined number, the number of concurrent memory access operations.

7. The system of claim 6, wherein performing the thermal throttling operation comprises:
responsive to determining that the number of concurrent memory access operations does not satisfy a maximum threshold criterion, setting the number of concurrent memory access operations equal to a predefined maximum value.

8. The system of claim 1, wherein performing the thermal throttling operation comprises:
identifying a number of concurrent memory access operations being performed at a block of the memory device; and
setting the number of concurrent memory access operations equal to a predefined maximum value.

9. The system of claim 1, wherein performing the thermal throttling operation comprises:
identifying a number of concurrent memory access operations being performed at a block of the memory device; and
setting the number of concurrent memory access operations equal to a predefined minimum value.

10. The system of claim 1, further comprising:
determining that the temperature value of the plurality of temperature values does not exceed a respective thermal shutdown threshold of a plurality of thermal shutdown thresholds.

11. A method comprising:
receiving, by a processing device, a plurality of temperature values of the memory device;
determining that a temperature value of the plurality of temperature values satisfies a thermal throttling threshold of a plurality of thermal throttling thresholds, wherein each thermal throttling threshold of the plurality of thermal throttling thresholds triggers a corresponding thermal throttling state of the memory device; and
responsive to determining that the temperature value satisfies the respective thermal throttling threshold, performing a thermal throttling operation associated with the corresponding thermal throttling state.

12. The method of claim 11, wherein performing the thermal throttling operation comprises:
identifying a number of concurrent memory access operations being performed at a block of the memory device; and
reducing, by a respective predefined number, the number of concurrent memory access operations, wherein the respective predefined number is based on the corresponding thermal throttling state.

13. The method of claim 12, further comprising:
responsive to determining that the number of concurrent memory access operations does not satisfy a minimum threshold criterion, setting the number of concurrent memory access operations equal to a predefined minimum value.

14. The method of claim 11, wherein performing the thermal throttling operation comprises:
increasing, by a predefined number, the number of concurrent memory access operations.

15. The method of claim 11, wherein performing the thermal throttling operation comprises:
setting the number of concurrent memory access operations equal to a predefined maximum value.

16. The method of claim 11, wherein performing the thermal throttling operation comprises:
setting the number of concurrent memory access operations equal to a predefined minimum value.

17. A non-transitory computer-readable storage medium comprising instructions that, when executed by a processing device, cause the processing device to perform operations comprising:
measuring a plurality of temperature values of the memory device at a predefined frequency;
determining that a temperature value of the plurality of temperature values satisfies a thermal throttling threshold of a plurality of thermal throttling thresholds, wherein each thermal throttling threshold of the plurality of thermal throttling thresholds triggers a corresponding thermal throttling state of a plurality of thermal throttling states of the memory device; and
responsive to determining that the temperature value satisfies the respective thermal throttling threshold, performing a thermal throttling operation associated with the corresponding thermal throttling state.

18. The non-transitory computer-readable storage medium of claim 17, wherein performing the thermal throttling operation comprises:
identifying a number of concurrent memory access operations being performed at a block of the memory device; and
reducing, by a respective predefined number, the number of concurrent memory access operations, wherein the respective predefined number is based on the corresponding thermal throttling state.

19. The non-transitory computer-readable storage medium of claim 17, wherein performing the thermal throttling operation comprises:
identifying a number of concurrent memory access operations being performed at a block of the memory device; and
increasing, by a predefined number, the number of concurrent memory access operations.

20. The non-transitory computer-readable storage medium of claim 17, wherein performing the thermal throttling operation comprises:
identifying a number of concurrent memory access operations being performed at a block of the memory device; and
setting the number of concurrent memory access operations equal to a predefined maximum value.
